(19) United States
(12) Patent Application Publication
(10) Pub. No.: US 2009/0066892 A1
(43) Pub. Date: Mar. 12, 2009

(54) LIGHT DIFFUSER PLATE WITH LIGHT-COLLECTING LAYER, SURFACE LIGHT SOURCE DEVICE AND LIQUID CRYSTAL DISPLAY DEVICE

(75) Inventors: Hiroyuki Kumasawa, Niihama-shi (JP); Akiyoshi Kanemitsu, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/199,846

(22) Filed: Aug. 28, 2008

(30) Foreign Application Priority Data
Sep. 7, 2007 (JP) 2007-232875

(51) Int. Cl. G02F 1/1335; F21V 11/00

(52) U.S. Cl. 349/112; 362/355

(57) ABSTRACT

The present invention provides a light diffuser plate with a light-collecting layer, which can be sufficiently prevented from flawing and which can ensure a sufficient luminance in a front direction.

A light diffuser plate 3 with a light-collecting layer, of the present invention, comprises a light-diffusing substrate 31 and a light-collecting sheet 32 which are disposed in a stacked state and are united at their peripheral portions so that an air layer 33 is formed between the light-diffusing substrate 31 and the light-collecting sheet 32.

### BACKGROUND OF THE INVENTION

1. Field of the Invention

This application was filed claiming Paris Convention priority of Japanese Patent Application No. 2007-232875, the entire content of which is herein incorporated by reference.

The present invention relates to a light diffuser plate with a light-collecting layer, sufficiently prevented from flawing and capable of ensuring a sufficient luminance in the front direction, a high quality surface light source device showing a sufficient luminance in the front direction, and a liquid crystal display device.

2. Description of the Related Art

For example, there is known a liquid crystal display device in which a surface light source device as a backlight is disposed on the rear side of a liquid crystal panel (i.e., an image-displaying member) comprising a liquid crystal cell. As the surface light source device as the backlight, there is known a surface light source device which comprises a plurality of light sources disposed in a lamp box (or a casing), a light diffuser plate disposed on the front side of the light sources, and a lenticular sheet as a light-collecting sheet, disposed on the front side of the light diffuser plate. For example, Japanese Patent No. 3123006 discloses a surface light source device having the above-described structure.

### SUMMARY OF THE INVENTION

However, the above-described surface light source device has a problem in that the light diffuser plate and the light-collecting sheet rub on each other and are subject to flaws, since the light-collecting sheet is simply stacked on the front side of the light diffuser plate.

The present invention is made in consideration of the above-described technical background. Objects of the present inventions are therefore to provide a light diffuser plate with a light-collecting layer, sufficiently prevented from flawing and capable of ensuring a sufficient luminance in the front direction, a high quality surface light source device showing a sufficient luminance in the front direction, and a liquid crystal display device.

### Means for Solving the Problem

To achieve the objects, the present invention provides the following means.
[1] A light diffuser plate with a light-collecting layer, comprising a light-diffusing substrate and a light-collecting sheet, which are disposed in a stacked state and are united at their peripheral portions, wherein an air layer is formed between the light-diffusing substrate and the light-collecting sheet.
[2] A surface light source device comprising the light diffuser plate with the light-collecting layer according to the above item 1, and a plurality of light sources disposed on the rear side of the light diffuser plate, wherein the light-collecting sheet is disposed on the front side in the light diffuser plate.
[3] A liquid crystal display device comprising the light diffuser plate with the light-collecting layer according to the above item 1, a plurality of light sources disposed on the rear side of the light diffuser plate, and a liquid crystal panel disposed on the front side of the light diffuser plate, wherein the light-collecting sheet is disposed on the front side in the light diffuser plate.

### BRIEF DESCRIPTION OF THE DRAWINGS

FIG. 1 is a schematic diagram illustrating an embodiment of a liquid crystal display device according to the present invention.

FIG. 2 is a perspective view of an embodiment of a light diffuser plate with a light-collecting layer according to the present invention.

FIG. 3 is a sectional view of the light diffuser plate shown in FIG. 2, taken along line X-X.

FIG. 4 is a sectional view of another embodiment of a light diffuser plate with a light-collecting layer according to the present invention.

FIG. 5 is a perspective view of other embodiment of a light diffuser plate with a light-collecting layer according to the present invention.

### BRIEF DESCRIPTION OF THE REFERENCE NUMERALS

1=a surface light source device
2=a light source
3=a light diffuser plate
20=a liquid crystal panel
30=a liquid crystal display device
31=a light-diffusing substrate
32=a light-collecting sheet
33=an air layer
34=a peripheral united portion
Q=a front direction (or a normal line direction)

### DETAILED DESCRIPTION OF THE INVENTION

According to the invention of the item [1], the light-diffusing substrate and the light-collecting sheet are united at their peripheral portions, and therefore, the light-diffusing substrate and the light-collecting sheet do not rub on each other, so that flawing of the light diffuser plate can be sufficiently prevented. Further, the air layer is formed between the light-diffusing substrate and the light-collecting sheet at the region excluding their peripheral united portion, and therefore, the luminance of the light diffuser plate in the front direction can be sufficiently ensured.

According to the invention of the item [2], the light diffuser plate with the light-collecting layer has no flaw thereon, and thus can provide a surface light source device capable of emitting high quality light and showing a high luminance in the front direction.

According to the invention of the item [3], the light diffuser plate with the light-collecting layer has no flaw thereon, and thus can provide a liquid crystal display device capable of obtaining a high quality image and showing a high luminance in the front direction.

### BEST MODES FOR CARRYING OUT THE INVENTION

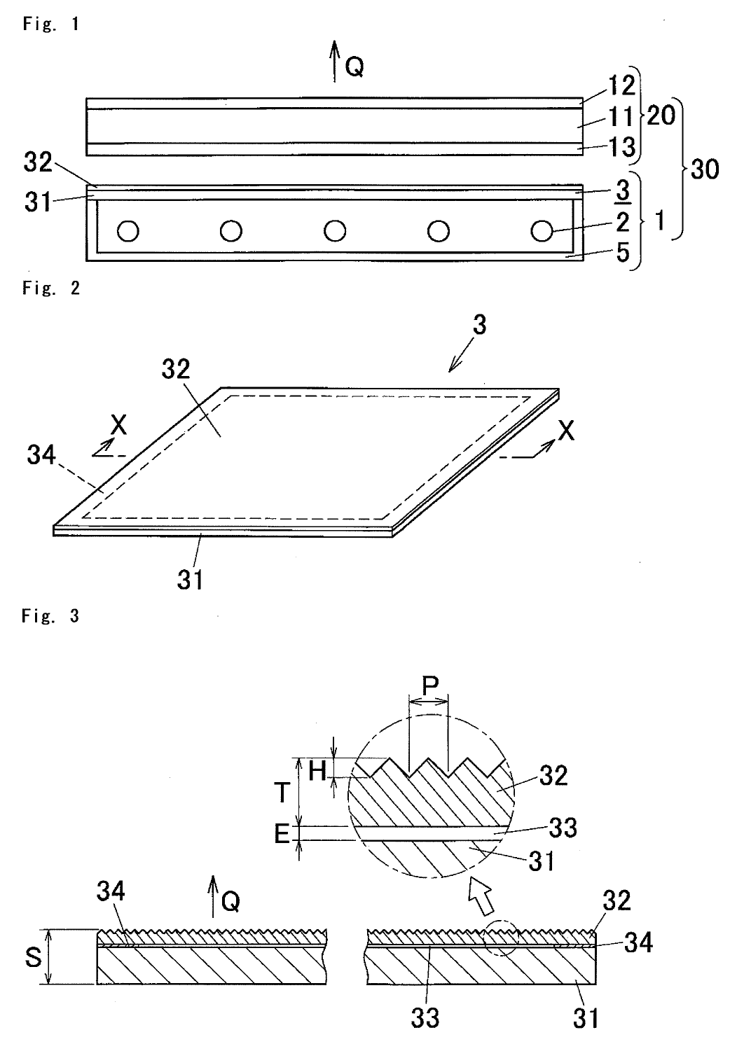

An embodiment of a liquid crystal display device according to the present invention is illustrated in FIG. 1. In FIG. 1, numeral (30) refers to a liquid crystal display device; (11), to a liquid crystal cell; (12) and (13), to polarizing plates; and (1), to a surface light source device (i.e., a backlight). The polarizing plates (12) and (13) are disposed on the upper and lower sides of the liquid crystal cell (11), respectively, so that these members (11), (12) and (13) constitute a liquid crystal panel (20) as an image display. As the liquid crystal cell (11), such one that can display a colored image is preferably used.

The surface light source device (1) is disposed on the lower side of the polarizing plate (13) on the lower side of the liquid crystal panel (20) (i.e., on the rear side of the liquid crystal panel). In other words, this liquid crystal display device (30) is a direct type liquid crystal display device.

The surface light source device (1) comprises a lamp box (5) in the shape of a casing with a low height, which is opened at its upper side (or the front side) and is seen to be rectangular when viewed from just above; a plurality of light sources (2) spaced to one another in the lamp box (5); and a light diffuser plate (3) disposed on the upper side (or the front side) of the plurality of light sources (2). The light diffuser plate (3) is so fixed to the lamp box (5) as to close the opening of the lamp box (5). Further, a light-reflecting layer (not shown) is provided on the inner surfaces of the lamp box (5). While there is no limit in selection of the light sources (2), for example, cold cathode ray tubes, light-emitting diode (or LEDs) or the like are used.

The light diffuser plate (3) comprises, as shown in FIGS. 2 and 3, a light-diffusing substrate (31) and a light-collecting sheet (32), which are disposed in parallel to each other and are united to each other at their peripheral portions to form an air layer (33) between the light-diffusing substrate (31) and the light-collecting sheet (32) at the region excluding their peripheral united portion (34). In this embodiment, the peripheral portion of the light-diffusing substrate (31) is united to the peripheral portion of the light-collecting sheet (32) through the peripheral united portion (34) comprising an adhesive resin. Again, in this embodiment, the light-diffusing substrate (31) and the light-collecting sheet (32) are disposed in a non-contact stacked state, and thus do not contact each other (see FIG. 3).

In the liquid crystal display device (30), the light diffuser plate (3) is disposed with its light-collecting sheet (32) located on the front side (on the side of the liquid crystal panel (20)) (see FIG. 1). In other words, in the liquid crystal display device (30), the light diffuser plate (3) is disposed with its light-diffusing layer (31) located on the rear side (on the side of the light sources (2)) (see FIG. 1).

The light diffuser plate (3) of the above structure can be surely prevented from flawing, because the light-diffusing substrate (31) does not rub on the light-collecting sheet (32) due to their peripheral unit. The light diffuser plate (3) also has the air layer (33) between the light-diffusing substrate (31) and the light-collecting sheet (32) at its region excluding the peripheral united portion (34). Accordingly, the surface light source device (1) is enabled to illuminate at a higher luminance in the front direction (or the normal line direction) (Q); and the liquid crystal display device (30) is enabled to display an image with a higher luminance in the front direction (or the normal line direction) (Q).

In the liquid crystal display device (30), the peripheral united portion (34) of the light diffuser plate (3) is preferably designed to have such dimensions as can be hidden by the shielding frame portion (colored black or the like) surrounding the image display region. In this case, an adverse influence of the peripheral united portion (34) on a displayed image can be surely eliminated.

In this embodiment, the peripheral portion of the light-diffusing substrate (31) is united to the peripheral portion of the light-collecting sheet (32) through the peripheral united portion (34) comprising the adhesive resin. However, the means for the peripheral joint is not limited to the adhesive resin, and any means may be used, in so far as the peripheral portion of the light-diffusing substrate (31) can be united to the peripheral portion of the light-collecting sheet (32). Specific examples of such means include laser welding, hot welding, ultrasonic welding, sewing with a thread-like material, adhesive tape, bonding with adhesive particles, etc.

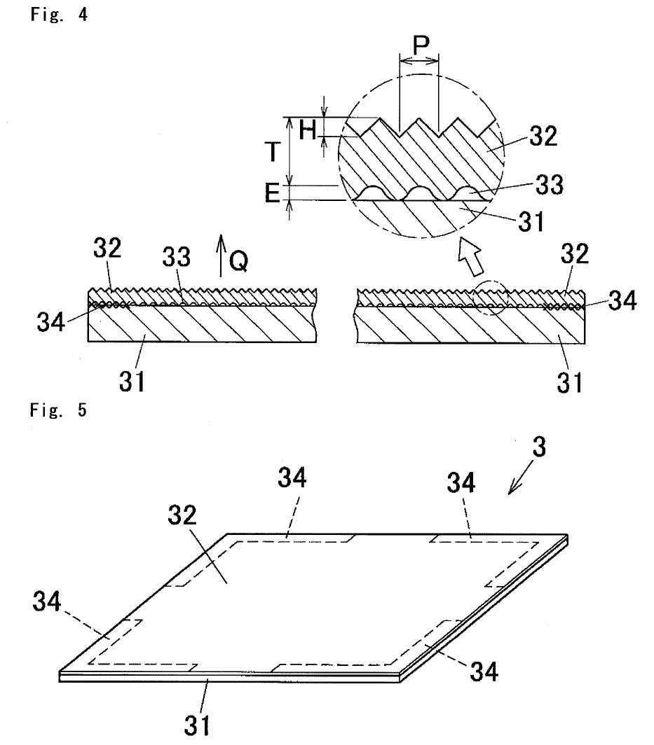

In the present invention, it is needed to form the air layer (33) between the light-diffusing substrate (31) and the light-collecting sheet (32) at the region excluding the above-described peripheral united portion (34). In this regard, the term of “the air layer” is used including a state of the light-diffusing substrate (31) and the light-collecting sheet (32) which are not in optically tight contact with each other. This is described with reference to, for example, FIG. 4: the light-collecting sheet (32) of which the united surface is uneven is stacked on the light-diffusing substrate (31) in a contact state, and they are united to each other at their peripheral portions through the peripheral united portion (34) by welding, so that the air layer (33) is formed between the light-diffusing substrate (31) and the light-collecting sheet (32) at the region excluding this peripheral united portion (34). In the structure shown in FIG. 4, parts of the uneven surface of the light-collecting sheet (32) contact the light-diffusing substrate (31) at the region excluding the peripheral united portion (34). However, the above-described uneven surface does not allow optically tight contact between the light-diffusing substrate (31) and the light-collecting sheet (32), and thus, the air layer (33) is formed between the light-diffusing substrate (31) and the light-collecting sheet (32).

It is to be noted that, when the light-diffusing substrate (31) is in optically tight contact with the light-collecting sheet (32) (or when no air layer is formed between each of them), it is impossible to obtain a sufficient luminance in the front direction (Q).

In the present invention, the light-diffusing substrate (31) may be any one that can diffuse transmitted light. Among such materials, a plate of a transparent material having light-diffusing particles (light diffuser) dispersed therein is preferably used.

The transparent material constituting the light-diffusing substrate (31) is not limited. Examples of such a material include transparent resins, inorganic glass, etc. As the transparent resins, transparent thermoplastic resins are preferably used because of their molding ease. Examples of the transparent thermoplastic resins include, but not limited to, polycarbonate resins, ABS resins (or acrylonitrile-butadiene-styrene copolymer resins), methacrylic resins, methyl methacrylate-styrene copolymer resins, polystyrene resins, AS resins (or acrylonitrile-styrene copolymer resins), polyolefin resins (e.g., polyethylene resins, polypropylene resins, etc.) and the like.

The above-described light-diffusing particles are not limited, and there can be used any kind of particles that are incompatible with the transparent resin constituting the light-diffusing substrate (31) and have a different refractive index from the transparent resin, and that can diffuse transmitted light. Examples of the light-diffusing particles include inorganic particles such as silica particles, calcium carbonate particles, barium sulfate particles, titanium oxide particles, aluminum hydroxide particles, inorganic glass particles, mica particles, talc particles, white carbon particles, magnesium oxide particles and zinc oxide particles; and organic particles such as methacrylic crosslinked resin particles, methacrylic polymeric resin particles, styrenic crosslinked particles, styrenic polymeric resin particles and siloxane-based polymer particles. At least one kind of particles of the above-described kinds of particles or two ore more kinds of particles thereof as a mixture may be used as the light-diffusing particles.

Usually, the light-diffusing particles having a volume-average particle size of from 0.1 to 50 μm are used. The volume-average particle size (D50) is the particle size of a particle determined as follows: the particle sizes and volumes of all the particles are measured; and the volumes of the particles are integrated in the order from a particle with the smallest particle size, to find an integrated volume which is 50% of the total volume of all the particles; and the particle size of the particle found when the integrated volume reaches 50% of the total volume is measured.

The amount of the light-diffusing particles to be used is varied in accordance with an intended degree of diffusion of transmitted light. Usually, 0.01 to 20 parts by mass of the light-diffusing particles are contained in 100 parts by mass of the transparent resin. Preferably, 0.1 to 10 parts by mass of the light-diffusing particles are contained in 100 parts by mass of the transparent resin.

The thickness of the light-diffusing substrate (31) is usually set at from 0.1 to 10 mm.

While the above-described light-collecting sheet (32) is not limited, there is used, for example, a sheet in which fine light-collecting lenses such as fine prism lenses, fine convex lenses, lenticular lenses or the like are formed on its one entire surface. The light-collecting sheet (32) collects light rays which transmit the light-diffusing substrate (31) while being diffused, in the normal line direction (Q) to the light diffuser plate (3).

Examples of a material for the light-collecting sheet (32) include, but not limited to, polycarbonate resins, ABS resins (or acrylonitrile-butadiene-styrene copolymer resins), methacrylic resins, methyl methacrylate-styrene copolymer resins, polystyrene resins, AS resins (or acrylonitrile-styrene copolymer resins), polyolefin resins (e.g., polyethylene resins, polypropylene resins, etc.) and the like. While there is no limit in selection of commercially available products of the light-collecting sheet (32), there are exemplified “BEFS” manufactured by SUMITOMO 3M LIMITED (a laminate comprising a polyester film with a thickness of 125 μm and an acrylic resin layer with a thickness of 30 μm which is formed on the polyester film and which has V-shaped grooves with depths (H) of 25 μm and with opening angles of 90° at the bottom, formed at pitch intervals (P) of 50 μm on its surface) (see FIG. 2); “ESTINA®” manufactured by SEKISUI FILM CO., LTD., etc.

The thickness (T) of the light-collecting sheet (32) is usually set at from 0.02 to 5 mm, and it is preferably from 0.02 to 2 mm.

The thickness (E) of the air layer (33) is usually set at from 1 to 100 μm, and it is preferably from 5 to 20 μm.

While the adhesive resin which forms the above-described peripheral united portion (34) is not limited, there is used, for example, an acrylic resin, an urethane-based resin, a polyether resin, a silicone-based resin, an epoxy-based resin or the like. The refractive index of the adhesive resin is not particularly limited.

The larger the area of the above-described peripheral united portion (34) (the area as the front view), the better, from the viewpoint of improvement of the joint strength. On the other hand, it is desirable not to project the peripheral united portion (34) from the region hidden by the shielding frame portion (colored black or the like) surrounding the image display region, as much as possible, from the viewpoint of surely avoiding the influence of the peripheral united portion (34) on a displayed image. In consideration of both the viewpoints, the area of the peripheral united portion (34) (the area as the front view thereof) is preferably 3 to 20% of the entire area of the laminate of the light-diffusing substrate (31) and the light-collecting sheet (32).

In this embodiment, the peripheral united portion (34) is formed in the shape of a frame in front view, which is continuous in the lengthwise directions of the peripheral edge portion (see FIG. 2). However, the shape of the peripheral united portion is not limited to this one: that is, as shown in FIG. 5, the peripheral united portion may be formed discontinuously in the lengthwise directions of the peripheral edge portion.

Preferably, at least one of the joining surface of the light-collecting sheet (32) and the joining surface of the light-diffusing substrate (31) is uneven, in order not to cause optically tight contact between the light-collecting sheet (32) and the light-diffusing substrate (31) even when both of them contact each other, in other words, in order to ensure the air layer (33) between the light-collecting sheet (32) and the light-diffusing substrate (31), even when they contacts each other. The ten-point height of irregularities Rz of this uneven surface (according to JIS B0601-2001) is preferably from 1.0 to 100 μm, more preferably from 1.0 to 50 μm.

The light diffuser plate (3) of the present invention can be manufactured by hot pressing, using, for example, the above-described adhesive resin, or by hot welding or the like. These methods are illustrative only, and the light diffuser plate (3) of the present invention is not limited to ones manufactured by these methods in any way.

The thickness (S) of the light diffuser plate (3) of the present invention is usually set at from 0.1 to 15 mm. The dimensions (or the area) of the light diffuser plate (3) is not limited, and may be appropriately selected in accordance with, for example, the dimensions of an intended surface light source device (1) or an intended liquid crystal display device (30). It is usually set at an area of 20 cm×30 cm to 150 cm×200 cm.

The light diffuser plate (3), the surface light source device (1) and the liquid crystal display device (30) according to the present invention are not limited to the above-described embodiments, and may be altered in their designs without departing from the spirit of the present invention.

### EXAMPLES

Next, specific Examples of the present invention will be explained. However, the scope of the present invention is not limited to the following Examples in any way.

### Example 1

An acrylic resin adhesive was applied to the peripheral portion of the upper and uneven surface of a light-diffusing substrate (31) with a thickness 2.0 mm, which had a total light transmittance of 70% measured according to JIS K-7361 (in which the uneven surface had an Rz of 2.3 μm, measured according to JIS B0601-2001). After that, a light-collecting sheet (32) was stacked and pressed onto the uneven surface of the light-diffusing substrate (31) to fabricate a light diffuser plate (3) comprising the light-diffusing substrate (31) and the light-collecting sheet (32) which were disposed in a stacked state and were united at their peripheral portions as shown in FIGS. 2 and 3. As the light-collecting sheet (32), there was used “BEF®” manufactured by SUMITOMO 3M LIMITED (a laminate comprising a polyester film with a thickness of 125 μm and an acrylic resin layer with a thickness of 30 μm which was formed on the polyester film and which had V-shaped grooves with depths (H) of 25 μm and with opening angles of 90° at the bottom, formed at pitch intervals (P) of 50 μm on its surface) (see FIG. 2). In the resultant light diffuser plate (3), the thickness (E) of an air layer (33) was 10 μm, and the ratio of the area of the peripheral united portion (34) to the entire area of the laminate of the light-diffusing substrate (31) and the light-collecting sheet (32) was 11.5%.

Next, a surface light source device (1) having the above-described structure shown in FIG. 1 was fabricated using this light diffuser plate (3). As light sources (2), cold cathode ray tubes were used. The luminance of this surface light source device (1) in the front direction (or the normal line direction) (Q) was measured. As a result, it was 7,367 cd/m².

### Comparative Example 1

A surface light source device was fabricated in the same manner as in Example 1, except that the acrylic resin adhesive was applied to the entire area of the upper surface of the above-described light-diffusing substrate, followed by stacking and pressing the above-described light-collecting sheet (“BEF®” manufactured by SUMITOMO 3M LIMITED) onto the light-diffusing substrate. The luminance of this surface light source device in the front direction (or the normal line direction) was measured. As a result, it was 5,213 cd/m².

The surface light source device of Example 1, fabricated using the light-diffuser plate of the present invention could obtain a sufficiently high luminance in the front direction (or the normal line direction). In the light diffuser plate of Example 1, the light-diffusing substrate and the light-collecting sheet were united at their peripheral portions, and thus, the light-diffusing substrate and the light-collecting sheet did not rub on each other. Consequently, the light diffuser plate did not suffer from any frictional flaw.

In contrast, in the light diffuser plate of Comparative Example 1, the application of the adhesive to the entire area of the surface of the light-diffusing substrate permitted no air layer between the light-diffusing substrate and the light-collecting sheet. Accordingly, the resultant surface light source device could not obtain a sufficient luminance in the front direction (or the normal line direction).

The light diffuser plate of the present invention is preferably used in a surface light source device. However, the application of the light diffuser plate is not limited thereto. The surface light source device of the present invention is preferably used as a backlight for a liquid crystal display device. However, the application of the surface light source device is not limited thereto.

What is claimed is:

1. A light diffuser plate with a light-collecting layer, comprising a light-diffusing substrate and a light-collecting sheet, which are disposed in a stacked state and are united at their peripheral portions, wherein an air layer is formed between the light-diffusing substrate and the light-collecting sheet.

2. A surface light source device comprising the light diffuser plate with the light-collecting layer according to claim 1, and a plurality of light sources disposed on the rear side of the light diffuser plate, wherein the light-collecting sheet is disposed on the front side in the light diffuser plate.

3. A liquid crystal display device comprising the light diffuser plate with the light-collecting layer according to claim 1, a plurality of light sources disposed on the rear side of the light diffuser plate, and a liquid crystal panel disposed on the front side of the light diffuser plate, wherein the light-collecting sheet is disposed on the front side in the light diffuser plate.
